(19) United States
(12) Patent Application Publication
(10) Pub. No.: US 2007/0247562 A1
(43) Pub. Date: Oct. 25, 2007

(54) Prism sheets for liquid crystal displays

(75) Inventors: Sung-Kyu Shim, Seoul (KR); Hyoung-Joo Kim, Uiwang-si (KR); In-Sun Hwang, Sowon-si (KR); Seong-Yong Hwang, Seongnam-si (KR)

Correspondence Address: MACPHERSON KWOK CHEN & HEID LLP, 2033 GATEWAY PLACE, SUITE 400, SAN JOSE, CA, 95110, US

(73) Assignee: SAMSUNG ELECTRONICS CO., LTD., Suwon-si (KR)

(21) Appl. No.: 11/544,049

(22) Filed: Oct. 3, 2006

(30) Foreign Application Priority Data
Apr. 19, 2006 (KR) 10-2006-0035225

(51) Int. Cl. G02F 1/1335

(52) U.S. Cl. 349/64

(57) ABSTRACT

A liquid crystal display (LCD) includes an image display unit, a backlight unit that supplies light to the display unit, and an optical film unit including a diffusion sheet and a prism sheet disposed between the display and the backlight units. The prism sheet includes right angle prisms and acute angle prisms that are greater in height than the right angle prisms, which are formed together in the prism film. The arrangement of prisms enables light that would otherwise be lost inside of the display to be recycled, thereby providing an increase in the efficiency of light use by the display and an increase in the angle at which light exits it.

### RELATED APPLICATIONS

This application claims priority of Korean Patent Application No. 10-2006-0035225, filed Apr. 19, 2006, the entire contents of which are incorporated herein by reference.

### BACKGROUND

The present invention relates to liquid crystal displays (LCDs) in general, and in particular, to a prism sheet for use in an LCD that enhances the efficiency of light use by the display.

A typical LCD includes two display panels, each provided with electric field generating electrodes, and a liquid crystal layer having dielectric anisotropy interposed therebetween. A voltage is applied to the electrodes to generate an electric field in the liquid crystal layer, and the intensity of the electric field controls the transmittance of light passing through the liquid crystal layer so as to produce a desired image on the display.

The LCD may include a backlight unit that generates a field of light, an optical film unit that operates to make the luminance of the light generated by the backlight unit to be uniform, and a display unit that displays an image using the uniform light. The optical film unit comprises a diffusion sheet, a prism sheet, and a luminance enhancement sheet.

In a cross-sectional view, the prism sheet of the film unit may define a plurality of triangular prisms disposed immediately adjacent to each other. At a surface of each prism that is inclined at a selected angle relative to the sheet, light that is incident on the sheet is refracted so as to exit in a direction substantially vertical to the plane of the liquid crystal panel. Accordingly, the prism sheet functions to condense light emitted by the diffusion sheet in a direction substantially vertical to the plane of the liquid crystal panel so as to enhance the luminance of the display.

In a conventional LCD prism sheet, except for the light that exits from the top surface of the panel, the remaining light is “recycled” so as to exit again from the top surface of the panel, and accordingly, the greatest amount of light exiting the panel is found in a direction normal to the bottom surface of the prism sheet. Thus, while some of the light in the range of between about −60 degrees and about +60 degrees relative to this normal direction ultimately exits the display, a majority of the light exiting the prism at these wide angles cannot be recycled, but is simply dissipated within the display, and thereby lost. What is needed then is an improved prism sheet for an LCD that enables more of the light refracted by the sheet at these wide angles to be recycled, i.e., re-used, within the display, thereby increasing the display's light use efficiency.

### BRIEF SUMMARY

In accordance with the exemplary embodiments thereof described herein, the present invention provides a prism sheet for use in an LCD that substantially improves the light use efficiency of the display and enables an increase in the angle at which light exits from the display.

In one exemplary thereof, a liquid crystal display (LCD) comprises a display unit that displays an image, a backlight unit that supplies light to the display unit, and an optical film unit, including a diffusion sheet and a prism sheet, interposed between the display unit and the backlight unit.

The prism sheet includes a first prism having two inclined surfaces that intersect each other at an apex having a first included angle, and a second prism having two inclined surfaces that intersect each other at an apex having a second included angle that is smaller than the first included angle. The first included angle is equal to or greater than 90 degrees, and the second included angle is less than 90 degrees, and the second prism is greater in height than the first prism. Each of the two inclined surfaces of the second prism are bent so as to form an included angle that changes discontinuously.

In one advantageous embodiment, the apex of at least the second prism is rounded to provide more uniform light, and in another, the apices of both the first and second prisms are rounded.

A better understanding of the above and many other features and advantages of the improved prism sheets of the present invention and their advantageous application to LCDs may be obtained from a consideration of the detailed description of some exemplary embodiments thereof below, particularly if such consideration is made in conjunction with the appended drawings, wherein like reference numerals are used to identify like elements illustrated in one or more of the figures thereof.

### BRIEF DESCRIPTION OF THE DRAWINGS

FIG. 1 is schematic cross-sectional view of a liquid crystal display incorporating an exemplary embodiment of a prism sheet with acute angle prisms in accordance with the present invention;

FIG. 2 is a schematic partial cross-sectional view of a conventional LCD prism sheet incorporating right angled prisms, showing the path of propagation of light exiting one of the prisms thereof;

FIG. 3 is a schematic partial cross-sectional view of an exemplary embodiment of a prism sheet incorporating acute angle prisms in accordance with the present invention, showing the path of propagation of light exiting from a right angle prism and an acute angle prism thereof;

FIG. 4 are multiple views respectively illustrating optical simulation results for a conventional prism sheet, a prism sheet modified to incorporate a single acute angle prism, and a prism sheet incorporating a plurality of periodically distributed acute angle prisms;

FIG. 5 is a schematic partial cross-sectional view of an exemplary acute angle prism sheet in which the upper corners, or apices, of both the right angle prisms and the acute angle prisms thereof are rounded; and,

FIG. 6 is a schematic cross-sectional view of an exemplary acute angle prism sheet similar to that shown in FIG. 5, wherein the respective apices of only the acute angle prisms are rounded.

### DETAILED DESCRIPTION

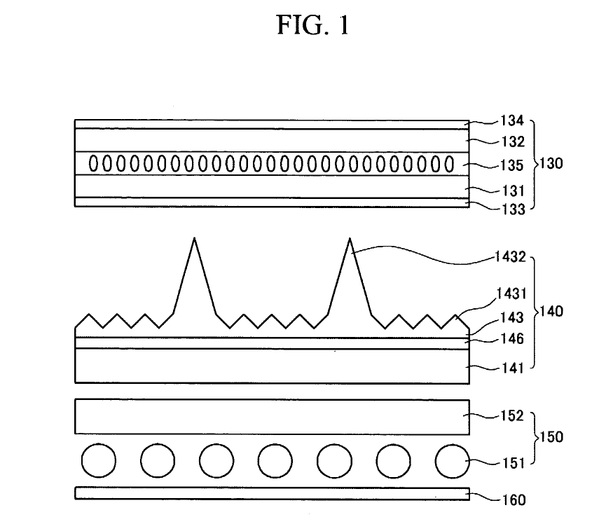

FIG. 1 is schematic cross-sectional view of a liquid crystal display (LCD) incorporating an exemplary embodiment of a prism sheet having acute angle prisms in accordance with the present invention. As shown in FIG. 1, the LCD includes a display unit 130 that displays an image, a backlight unit 150 that is positioned below the display unit 130 and supplies light to the display unit 130, an optical film unit 140 that makes the light generated by the backlight unit 150 uniform in luminance, and a reflection unit 160 disposed below the backlight unit 150, which acts to reflect any light propagating downward from the display unit 130.

The exemplary display unit 130 further includes a lower display panel 131, an upper display panel 132 facing the lower display panel 131, and a liquid crystal layer 135 interposed between the two panels. Additionally, lower and upper polarizers 133 and 134 are respectively disposed below the lower display panel 131 and above the upper display panel 132.

The lower display panel 131 functions to control the orientation of the liquid crystal molecules for each pixel of the display, and includes an insulating substrate, a plurality of pixel electrodes formed on the insulating substrate, and a plurality of thin film transistors (TFTs), each of which functions as a switching element. Each thin film transistor (TFT) corresponds to a three-terminal element having a gate electrode, a source electrode, and a drain electrode, and has a semiconductor layer that forms a current channel.

The upper display panel 132 functions to express colors, and includes an insulating substrate and a black matrix for preventing light leakage from the insulating substrate. A color filter is formed in a pixel area defined by the black matrix, and a common electrode made of transparent, electrically conductive materials, such as ITO (indium tin oxide) or IZO (indium zinc oxide), is formed on the color filter.

The backlight unit 150 includes a plurality of lamps 151 for generating light, and a light guiding plate 152 for guiding the light generated from the lamps 151 to the display unit 130. The lamp 151 of FIG. 1 is configured as a “direct” type of backlight unit in which the lamp 151 is disposed directly below the display unit 130 and the light guiding plate 152. The light guiding plate 152 is positioned directly below the display unit 130, and corresponds in size to the display unit 130. As shown in FIG. 1, the light guiding plate 152 may have a uniform thickness, or alternatively, may have a thickness that gradually increases or decreases across the width of the plate (not illustrated).

The optical film unit 140 is disposed on the light guiding plate 152 and functions to make the light propagating toward the display unit 130 substantially uniform in luminance, and the reflection unit 160 is disposed below the backlight unit 150 to re-reflect the light reflected back by the light guiding plate 152 back toward the light guiding plate 152, and thus improve the light use efficiency of the display.

The optical film unit 140 incorporates a plurality of optical sheets, including a diffusion film 141 that diffuses the light generated by the backlight unit 150, thereby resulting in a uniform luminance of the light, and a prism sheet 143 that acts to condense the uniform luminance light from the diffusion film 141.

In the particular exemplary embodiment illustrated in FIG. 1, the prism sheet 143 incorporates a plurality of right angle prisms 1431 distributed uniformly and continuously across the width of the sheet, and a plurality of acute angle prisms 1432 distributed periodically at selected intervals across the width of the film. Each of the right angle prisms 1431 has two inclined surfaces that intersect each other at an apex having an included right angle therebetween, and each of the acute angle prism 1432 has two inclined surfaces that intersect each other at an apex to form an included acute angle therebetween. Additionally, it should be understood that, even though right angle prisms 1431 are shown in the exemplary embodiment of FIG. 1, prisms 1431 having an obtuse angle, i.e., prisms having two inclined surfaces that intersect at an included angle of greater than 90 degrees, may be substituted for the right angle prisms 1431 of FIG. 1.

In the exemplary prism sheet 143 illustrated, the acute angle prisms 1432 are greater in height than the right angle prisms 1431. Additionally, in the acute angle prisms 1432, the two inclined surfaces are not formed of single planes, but are bent at the middle thereof. Therefore, each of the two inclined surfaces of the acute angle prisms 1432 forms an inclined angle that changes discontinuously. In a preferred embodiment, the acute angle prisms 1432 are made greater in height as the interval between the acute angle prisms 1432 increases. The angle between the two inclined surfaces of the acute angle prisms, as well the density ratio, i.e., the number of the acute angle prisms per unit width divided by the number of right angle prisms per unit width, can be adjusted in accordance with the required exit distribution of light.

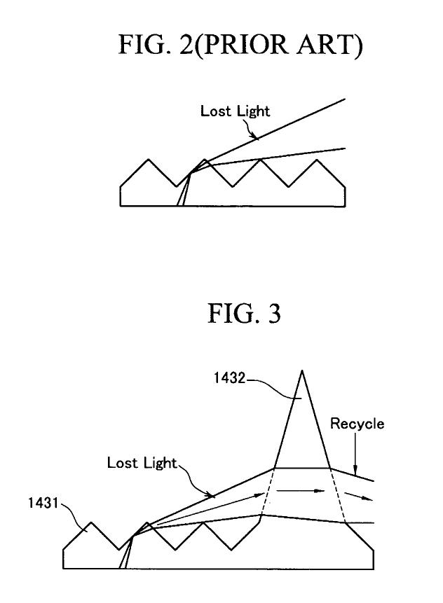

FIG. 2 is a schematic partial cross-sectional view of a conventional LCD prism sheet incorporating right angled prisms, showing the path of propagation of light exiting one of the prisms thereof. As shown in FIG. 2, in the conventional prism sheet, the exiting light may not be recycled, i.e., ultimately transmitted through the display panel 130, but instead, may be dissipated internally, or lost, depending on the angle at which the light exits the sheet. The present invention uses the acute angle prism sheet to reduce such light loss. The principal by which this recovery of lost light is effected is described below with reference to FIG. 3.

FIG. 3 is a schematic partial cross-sectional view of an exemplary embodiment of a prism sheet incorporating acute angle prisms in accordance with the present invention, showing the path of propagation of light exiting from a right angle prism and an acute angle prism thereof. As illustrated in FIG. 3, among the light ray components exiting through the right angle prism 1431, a light ray exiting at an angle at which the light would be lost, as above, in a conventional prism sheet is, in the acute angle prism sheet 143 of FIG. 3, incident instead on an adjacent acute angle prism 1432, is then refracted by the acute angle prism 1432 while passing therethrough, and is then again incident on the prism sheet 143. The light incident on the prism sheet 143 is in turn reflected by the reflection unit 160 after passing through the optical film unit 130 (see FIG. 1) and the backlight unit 150, and is thereby “recycled.” Accordingly, the acute angle prism 1432 enables the light that would otherwise be lost to be recycled, i.e., to be incident on the prism sheet 143 again, thereby increasing the efficiency of the panel's use of light. This means, for example, that all other things remaining equal, the image produced by the panel will be brighter than an image produced by a panel lacking the improved prism sheet, or alternatively, that it is capable of providing an image of the same brightness using less power.

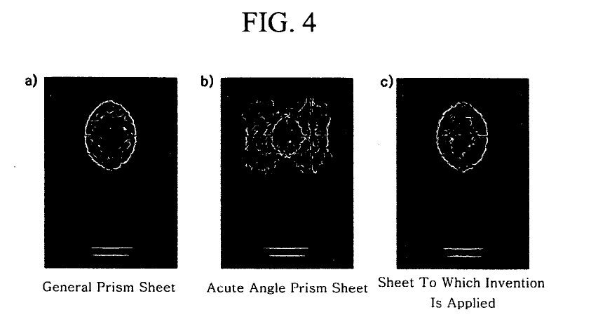

FIG. 4 are views respectively illustrating optical simulation results for a conventional prism sheet (left), a prism sheet modified to incorporate a single acute angle prism (center), and a prism sheet incorporating a plurality of periodically distributed acute angle prisms (right). As shown in these simulations, the prism sheet having only a single acute angle prism has the largest light distribution, but experiences a problem in that luminance of the central part of the sheet is relatively diminished. As may be seen by a comparison with the foregoing embodiment, the prism sheet in which a plurality of acute angle prisms are periodically distributed across the width of the sheet has an enhanced light distribution while yet maintaining an acceptable luminance at its central part. In particular, in the conventional prism sheet, the luminance decreases sharply within a range of about −35 to about +35 degrees with respect to a vertical axis through the sheet. In contrast, in the prism sheet with periodically distributed acute angle prisms, the luminance decreases much more gradually. Further, in the latter prism sheet, the amount of light exiting from the top surface of the sheet increases by more than 9%, as compared with the conventional prism sheet.

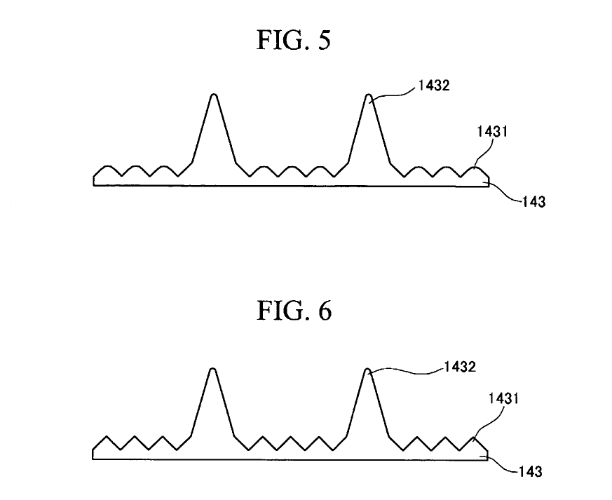

FIG. 5 is a schematic partial cross-sectional view of another exemplary embodiment of an acute angle prism sheet in accordance with the present invention in which the upper corners, or apices, of both the right angle prisms and the acute angle prisms thereof are rounded, and FIG. 6 is a schematic cross-sectional view of an exemplary acute angle prism sheet similar to that of FIG. 5, except that the respective apices of only the acute angle prisms are rounded. As illustrated in FIGS. 5 and 6, the prisms can be formed to have various advantageous shapes in the acute angle prism sheet.

In the exemplary embodiment of FIG. 5, the apices of both the right angle prisms 1431 and the acute angle prisms 1432 are rounded. In the exemplary embodiment of FIG. 6, the apices of only the acute angle prisms 1432 are rounded. It has been discovered that, if the apices of the prisms are formed with a rounded shape, the portions of the prism sheet at which the light refracted by the sheet changes discontinuously disappear, thereby improving the uniformity of the light transmitted through the sheet. Furthermore, when the sheet is used in an LCD, the use of rounded apices prevents the apices of the prism sheet from being deformed as a result of physical impact or friction.

In accordance with the present invention, the provision in an LCD of a prism sheet incorporating acute angle prisms distributed at intervals thereon enables an appreciable portion of the light that would otherwise be lost in the display to be re-incident on the prism sheet, so as to be recycled, thereby improving the light use efficiency of the display, and additionally, increasing or widening of the angle at which light exits the display.

By now, those of skill in this art will appreciate that many modifications, substitutions and variations can be made in and to the prism sheets of the present invention and their advantageous use in LCDs without departing from its spirit and scope. In light of this, the scope of the present invention should not be limited to that of the particular embodiments illustrated and described herein, as they are merely exemplary in nature, but instead, should be fully commensurate with that of the claims appended hereafter and their functional equivalents.

What is claimed is:

1. A liquid crystal display (LCD), comprising:
a display unit that displays an image;
a backlight unit that supplies light to the display unit; and,
an optical film unit, including a diffusion sheet and a prism sheet, interposed between the display unit and the backlight unit,
wherein the prism sheet includes a first prism having two inclined surfaces that intersect each other at an apex having a first included angle, and a second prism having two inclined surfaces that intersect each other at an apex having a second included angle that is smaller than the first included angle.

2. The LCD of claim 1, wherein the first included angle is equal to or greater than 90 degrees, and the second included angle is less than 90 degrees.

3. The LCD of claim 1, wherein the second prism is greater in height than the first prism.

4. The LCD of claim 3, wherein the two inclined surfaces of the second prism form an included angle that changes discontinuously.

5. The LCD of claim 1, wherein the apex of the second prism is rounded.

6. The LCD of claim 5, wherein the apex of the first prism is rounded.

7. A prism sheet, comprising a first prism having two inclined surfaces that intersect each other at an apex having a first included angle, and a second prism having two inclined surfaces that intersect each other at an apex having a second included angle that is smaller than the first included angle.

8. The prism sheet of claim 7, wherein the second prism is greater in height than the first prism.

9. The prism sheet of claim 8, wherein the two inclined surfaces of the second prism form an included angle that changes discontinuously.

10. The prism sheet of claim 9, wherein the apex of the second prism is rounded.

11. The prism sheet of claim 10, wherein the apex of the first prism is rounded.

12. The prism sheet of claim 7, wherein the first included angle is equal to or greater than 90 degrees, and the second included angle is less than 90 degrees.

13. An LCD incorporating a prism sheet in accordance with claim 7.

14. A method for increasing the efficiency of light use of an LCD, the method comprising incorporating a prism sheet in accordance with claim 7 between a backlight unit of the LCD and a display unit thereof.
